(19) United States
(12) Patent Application Publication
(10) Pub. No.: US 2016/0292578 A1
(43) Pub. Date: Oct. 6, 2016

(54) PREDICTIVE MODELING OF DATA CLUSTERS

(71) Applicant: BigML, Inc., Corvallis, OR (US)

(72) Inventor: Adam Ashenfelter, Corvallis, OR (US)

(73) Assignee: BigML, Inc., Corvallis, OR (US)

(21) Appl. No.: 15/089,387

(22) Filed: Apr. 1, 2016

Related U.S. Application Data
(60) Provisional application No. 62/142,727, filed on Apr. 3, 2015.

(51) Int. Cl. G06N 5/04; G06N 99/00; G06F 17/30

(52) U.S. Cl. CPC G06N 5/04; G06F 17/30598; G06F 17/30554; G06N 99/005

(57) ABSTRACT

The present disclosure pertains to a system and method for predictive modeling of data clusters. The system and method include creating a dataset from a data source comprising data points, identifying a number of clusters based at least in part on a similarity metric between the data points, generating a model for each of the number of clusters based at least in part on identifying the number of clusters, visually displaying the number of clusters, receiving an indication of selection of a particular cluster, and replacing the visual display of the identified number of clusters with a visual display of the model corresponding to the particular cluster in response to receiving an indication of selection of a model icon.

### RELATED APPLICATIONS

This application is a non-provisional of and claims priority benefit to pending U.S. provisional patent application No. 62/142,727, filed Apr. 3, 2015, all of which is incorporated by reference herein in its entirety.

### COPYRIGHT NOTICE

© 2015, 2016 BigML, Inc. A portion of the present disclosure may contain material that is subject to copyright protection. The copyright owner has no objection to the facsimile reproduction by anyone of the present disclosure, as it appears in the Patent and Trademark Office patent file or records, but otherwise reserves all copyright rights whatsoever.

### TECHNICAL FIELD

The present disclosure pertains to systems and methods for creating and visualizing clusters from large datasets and, more particularly, to predictive modeling of data clusters.

### BACKGROUND

Machine learning is a scientific discipline concerned with building models from data that can be used to make predictions or decisions. Machine learning may also be concerned with generating clusters that identify similarities among data. Machine learning may be divided into supervised learning and unsupervised learning. In supervised learning, a computing device receives a dataset having (existing) data points and their corresponding outcomes. The computing device's goal in supervised learning is to generate a model from the dataset that is used to predict an outcome for new data points. In the exemplary iris classification dataset in Table 1, the computing device's goal in supervised learning is to determine a model function “f” such that f(x)=y, where x are the (existing) inputs, e.g., sepal length, sepal width, petal length, and petal width, and y is the (existing) outcome, e.g., species. The computing device then can use the model to predict the outcome, e.g., the species, for new inputs, e.g., sepal length, sepal width, petal length, or petal width.

TABLE 1

| Sepal Length | Sepal Width | Petal Length | Petal Width | Species |
|---|---|---|---|---|
| 5.1 | 3.5 | 1.4 | 0.2 | Setosa |
| 5.7 | 2.6 | 3.5 | 1.0 | Versicolor |
| 6.7 | 2.5 | 5.8 | 1.8 | Virginica |
| . . . | . . . | . . . | . . . | . . . |

In unsupervised learning, the computing device receives a dataset that does not include outcomes. The computing device's goal in unsupervised learning is to uncover structure or similarity in the data points included in the dataset. One example of unsupervised learning is the creation of clusters from a dataset, in which each cluster represents groups of data points that are more similar to each other than those data points included in other clusters. In the exemplary iris classification dataset in Table 2, the computing device's goal in unsupervised learning would be to find a k number of clusters such that the data in each cluster is similar. The machine may select k points that are called centroids such that the total distance from each data point to its assigned centroid is minimized.

TABLE 2

| Sepal Length | Sepal Width | Petal Length | Petal Width |
|---|---|---|---|
| 5.1 | 3.5 | 1.4 | 0.2 |
| 5.7 | 2.6 | 3.5 | 1.0 |
| 6.7 | 2.5 | 5.8 | 1.8 |
| . . . | . . . | . . . | . . . |

The computing device must then visualize or render the model or cluster on a display device. While visualization has experienced continuous advances, visualizing a model or a cluster to facilitate further analysis of large datasets remains challenging.

### BRIEF DRAWINGS DESCRIPTION

FIG. 1 is a diagram of an exemplary predictive modeling system according to the present disclosure;

FIG. 2 is a diagram an embodiment of a computing system that executes the predictive modeling system shown in FIG. 1;

FIG. 3 is a display of an exemplary data source according to the present disclosure;

FIG. 4 is a display of an exemplary dataset according to the present disclosure;

FIGS. 5A-E are displays of an exemplary graphical user interface used to configure generation of a cluster according to the present disclosure;

FIGS. 6A-D are displays of an exemplary graphical user interface to display a cluster according to the present disclosure;

FIG. 7 is an exemplary graphical user interface to display a cluster and corresponding models of each cluster shown in FIGS. 6A-D according to the present disclosure;

FIGS. 8A-B are displays of an exemplary graphical user interface to display models of each cluster shown in FIGS. 6A-D according to the present disclosure;

FIG. 9 is a display of an exemplary dataset of a model shown in FIGS. 8A-D according to the present disclosure; and

FIG. 10 is a diagram of an exemplary algorithmic structure according to the present disclosure.

### DETAILED DESCRIPTION

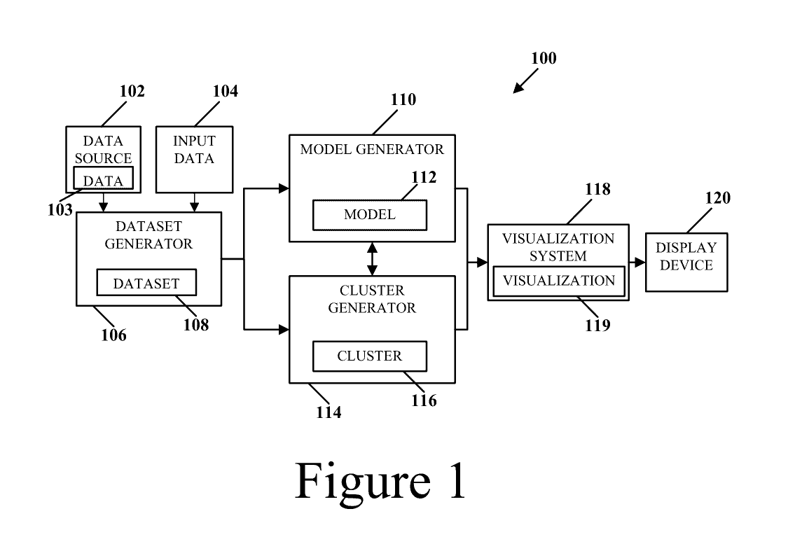

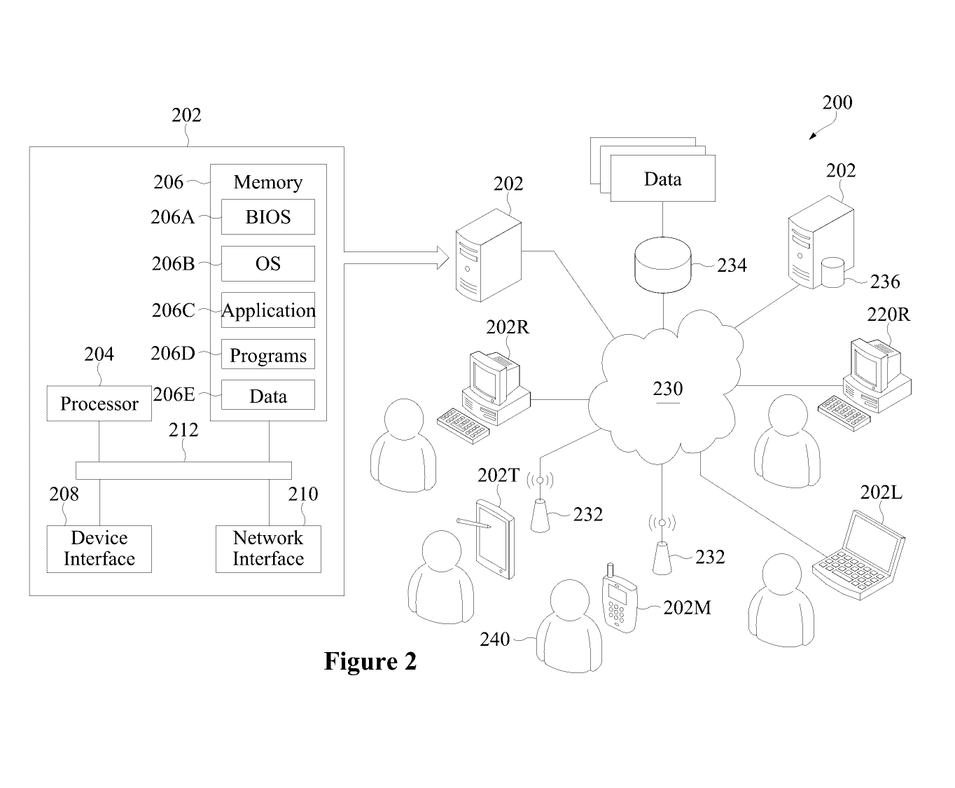

FIG. 1 is a diagram of an exemplary predictive modeling system 100 of the present disclosure. Referring to FIG. 1, system 100 may employ both supervised and unsupervised learning techniques and algorithmic structures to allow for the improved analysis and visualization of large datasets. System 100 may include a data source 102 to generate data 103 that is structured or organized, e.g., Table 1 or Table 2, which includes rows that represent fields or features and columns that represent instances of the fields or features. A last field may be the feature to be predicted, termed an outcome or an objective field, e.g., the column labeled “species” in Table 1. A first row of data 103 may be used as a header to provide field names or to identify instances. A field can be numerical, categorical, textual, date-time, or otherwise. Data source 102 may generate data 103 using any computing device capable of generating any kind of data, structured, organized, hierarchical, or otherwise, known to a person of ordinary skill in the art. In an embodiment, data source 102 may be any of computing devices 202 shown in FIG. 2 as described in more detail below.

A dataset generator 106 may generate a dataset 108 from data 103 and/or input data 104. Dataset generator 106 may generate a dataset 108 that is a structured version of data 103 where each field has been processed and serialized according to its type. Dataset 108 may comprise a histogram for each numerical, categorical, textual, or date-time field in data 103. Dataset 108 may show a number of instances, missing values, errors, and a histogram for each field in data 103. Dataset 108 may comprise any kind of data structured, organized, hierarchical, or otherwise. Dataset 108 may be generated from any type of data 103 or input data 104 as is well known to a person of ordinary skill in the art.

A model generator 110 may generate or build a model 112 based on dataset 108. Model generator 110 may use well-known supervised learning techniques to generate model 112 that, in turn, may be used to predict an outcome for new input data 104. For example, model 112 may be used to determine a model function “f” such that f(x)=y, where x are the inputs, e.g., sepal length, sepal width, petal length, and petal width, and y is the outcome or output, e.g., species as shown in Table 1. System 100 may use model 112 to predict the outcome, e.g., the species, for new input data 104 comprising, e.g., sepal length, sepal width, petal length, or petal width. In an embodiment, model generator 110 may generate a decision tree as model 112 with a series of interconnected nodes and branches as is described in the following commonly-assigned patent applications:

U.S. provisional patent application Ser. No. 61/881,566, filed Sep. 24, 2013, and entitled VISUALIZATION FOR DECISION TREES;

U.S. patent application Ser. No. 13/667,542, filed Nov. 2, 2012, published May 9, 2013, and entitled METHOD AND APPARATUS FOR VISUALIZING AND INTERACTING WITH DECISION TREES;

U.S. provisional patent application Ser. No. 61/555,615, filed Nov. 4, 2011, and entitled VISUALIZATION AND INTERACTION WITH COMPACT REPRESENTATIONS OF DECISION TREES;

U.S. provisional patent application Ser. No. 61/557,826, filed Nov. 9, 2011, and entitled METHOD FOR BUILDING AND USING DECISION TREES IN A DISTRIBUTED ENVIRONMENT;

U.S. provisional patent application Ser. No. 61/557,539, filed Nov. 9, 2011, and entitled EVOLVING PARALLEL SYSTEM TO AUTOMATICALLY IMPROVE THE PERFORMANCE OF DISTRIBUTED SYSTEMS; and

U.S. patent application Ser. No. 14/495,802, filed Sep. 24, 2014 and titled INTERACTIVE VISUALIZATION SYSTEM AND METHOD, all of which are incorporated by reference in their entirety.

Model generator 110 may generate a model 112 from any type or size of dataset 108. In an embodiment, model generator 110 may generate a decision tree that visually represents model 112 as a series of interconnected nodes and branches. The nodes may represent decisions and the branches may represent possible outcomes. Model 112 and the associated decision tree can then be used to generate predictions or outcomes for input data 104. For example, model 112 may use financial and educational data 103 about an individual to predict a future income level for the individual or generate a credit risk of the individual. Many other implementations are well known to a person of ordinary skill in the art.

A cluster generator 114 may generate a cluster 116 based on dataset 108. Cluster generator 114 may use well-known unsupervised learning techniques and/or algorithmic structures to detect or identify similarities in the dataset 108 to generate cluster 116. Cluster generator 114 may generate cluster 116 using any clustering algorithmic structures known to a person of ordinary skill in the art, including connectivity or hierarchical, centroid, statistical distribution, density, subspace, hard, soft, strict portioning with or without outliers, overlapping, or like clustering algorithmic structures. Cluster generator 114 may generate a cluster 116 from any type or size of dataset 108.

In an embodiment, cluster generator 114 may use a k-means centroid clustering algorithmic structure to generate cluster 116 after receiving a number “k” to identify the number of clusters desired and/or after providing a distance function. Cluster 116 may include a k number of clusters, where any particular cluster may represent a grouping of data points in dataset 108 that are more similar to each other than those data points are to other data points in other clusters, as represented by the distance function. K-means centroid clustering algorithmic structure may pick random points from dataset 108 as the initial centroids for the clusters. A poor selection of the initial centroids may lead to poor quality clusters, e.g., clusters that include data points that are not as similar to other data points in the cluster as desired. K-means clustering algorithmic structure may comprise randomly selecting a k number of initial centroids, testing each data point in the dataset against the centroids to determine the k number of clusters, updating the centroid by finding the center point in each cluster, and retesting each data point against the updated centroid. The process repeats until the centroid does not change significantly or at all. The iterative nature of k-means clustering algorithmic structure renders it computationally expensive particularly for large datasets with many rows. Further, k-means clustering algorithmic structure may randomly select initial centroids that may lead to unbalanced clusters with little value. Further still, k-means clustering algorithmic structure may require a k number of clusters rather than automatically discovering the (natural) number of clusters based on the dataset.

K-means++ clustering algorithmic structure may improve performance over the k-means clustering algorithmic structure by selecting higher quality initial centroids. The k-means++ algorithmic structure may select the first centroid randomly but then weigh data points against the first centroid to select other centroids that are spread out from the first centroid. K-means++ tests each remaining data point one at a time, weighing their selection according to how distant the data point is compared to the centroids. Clusters are created by associating every data point to one of the centroids based on the distance from the data point to the selected centroid. The result is that the centroids may be more uniformly spread out over data 103 than randomly selected centroids.

Mini-batch k-means algorithmic structure may improve k-means scalability with two techniques. First, when updating the cluster centroids, mini-batch k-means uses a random subsample of the dataset instead of the full dataset. Second, instead of moving the cluster centroid to the new center as computed with the sample, mini-batch k-means algorithmic structure may only shift the centroid in that direction (a gradient step). Sampling and gradient updates may combine to greatly reduce the computation time for finding cluster centroids on large datasets.

K-means∥(k-means pipe pipe) algorithmic structure may improve on the k-means algorithmic structure's initial centroid selection resulting in better quality final clusters particularly for large datasets. K-means∥algorithmic structure may use samples of data and select candidates in batches rather than one at a time. The result may be similar to that obtained using k-means++, i.e., uniformly sampled initial clusters but the implementation is improved by scaling the dataset to workable batches or samples. K-means∥algorithmic structure may sample multiple batches from the original dataset. However, each round of sampling is dependent on the previously sampled points. The further away a candidate point is from the already sampled points, the more likely it is to be selected in the next batch of samples. K-means∥algorithmic structure may thus result in an overall sample whose points tend to be well dispersed across the original dataset, as opposed to a purely random sample which will often contain points clumped near each other. K-means∥algorithmic structure may then run the traditional k-means algorithmic structure on the sample. The resulting cluster centroids are used as the initial centroids for the full k-means computation using any of the algorithmic structures detailed above, e.g., the mini-batch k-means algorithmic structure.

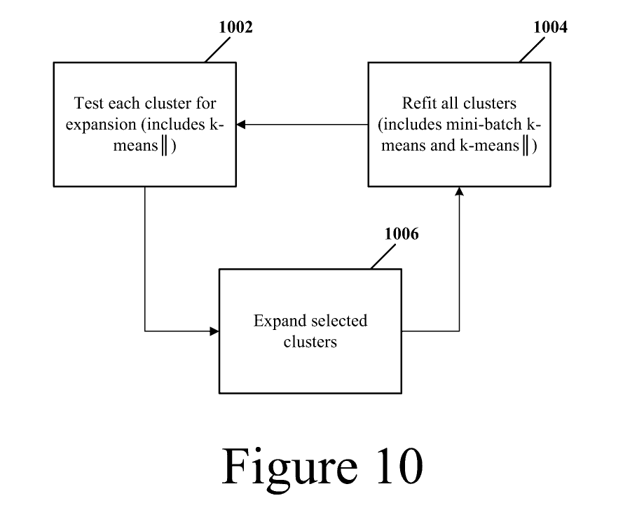

G-means algorithmic structure may automatically discover a number of clusters in the dataset using, e.g., a hierarchical approach, as shown in FIG. 10. The points nearest to a cluster's centroid define a cluster neighborhood. G-means algorithmic structure determines whether to replace a single cluster with two clusters by fitting two centroids (using, e.g., k-means algorithmic structure) to the neighborhood of the original cluster at 1002. The points in the neighborhood are projected onto the line between the two candidate centroids. If the distribution of the projected points appears Gaussian, the original single cluster is retained. If not, the original cluster is rejected and two new clusters are retained. After every cluster is considered for expansion (replaced by two clusters) at 1006, the resulting clusters are refit using, e.g., k-means algorithmic structure at 1004. The process repeats until no more clusters are expanded. G-means algorithmic structure may avoid scalability and initialization issues of k-means algorithmic structure by integrating k-means II algorithmic structure and mini-batch k-means techniques. K-means II algorithmic structure tests cluster expansions (by fitting two candidate clusters). Also, k-means II algorithmic structure and mini-batch algorithmic structures are used together when refitting all clusters at the end of each g-means algorithmic structure iteration.

Visualization system 118 may use the batches to calculate the centroids. Scaling dataset 108 to workable batches (i.e., smaller portions of dataset 108) improves overall performance, e.g., processing speed. Once a cluster is built, it may be used to predict a centroid (i.e., find the closest centroid for new input data 104) and also to create batch centroids.

In an embodiment, visualization system 118 may generate a visualization or rendering of model 112 or cluster 116 for display on display device 120 as well as generate an interactive graphical user interface also for display on display device 120 that controls dataset generator 106, model generator 110, or cluster generator 114 as we explain in more detail below. Display device 120 may be any type or size of display known to a person of ordinary skill in the art, e.g., liquid crystal displays, touch sensitive displays, light emitting diode displays, electroluminescent displays, plasma displays, and the like.

Visualization system 118 may generate and display visualization 119 of model 112 or cluster 116 to improve analysis of dataset 108 and data 103. In an embodiment, model 112 may be a decision tree with too many nodes and branches and too much text to clearly display the entire model 112 on a single screen of display 120. In an embodiment, cluster 116 may include too many clusters or clusters that are distantly separated from each other as to make difficult displaying all the clusters on a single screen of display device 120. A user may try to manually zoom into specific portions of model 112 or cluster 116. However, zooming into a specific area may prevent a viewer from viewing important information displayed in other areas of model 112 or cluster 116.

Visualization system 118 may generate visualization 119 to automatically prune model 112 to display the most significant nodes and branches. In an embodiment, a relatively large amount of dataset 108 may be used for generating or training a first portion of model 112 and a relatively small amount of dataset 108 may be used for generating a second portion of model 112. The larger amount of dataset 108 may allow the first portion of model 112 to provide more reliable predictions than the second portion of model 112.

Visualization system 118 may generate visualization 119 to scale model 112 to display clusters while maintaining a visual indication of a size of the cluster and a relative distance from other clusters. In some embodiments, visualization system 118 may generate visualization 119 to exclude display of some clusters, e.g., clusters distant from a majority of clusters, or to highlight some clusters, e.g., the largest or most significant clusters.

Visualization system 118 may generate visualization 119 to only display the nodes from model 112 that receive the largest amount of data points in dataset 108. This allows the user to more easily view the key decisions and outcomes in model 112. Visualization system 118 also may generate visualization 110 to display the nodes in model 112 in different colors that are associated with node decisions. The color coding scheme may visually display decision-outcome path relationships without cluttering a display of the model 112 with large amounts of text. More generally, visualization system 118 may generate visualization 119 to display nodes or branches of model 112 with different design characteristics depending on particular attributes of the data, e.g., color-coded, hashed, dashed, or solid lines or thick or thin lines, depending on another attribute of the data, e.g., sample size, number of instances, and the like.

Similarly, visualization system 118 may generate visualization 119 to display cluster 116 on display 120 in a manner calculated to ease analysis. For example, visualization system 118 may generate visualization 119 to display each cluster 116 as a circle having a size to indicate a number of data points or instances included in the cluster. Thus, larger circles represent clusters having a larger number of data instances and smaller circles represent cluster having a smaller number of data instances. Further, visualization system 118 may generate visualization 119 to display each cluster 116 in a different color to ease distinguishing one cluster from another. In an embodiment, visualization system 118 may generate visualization 119 to display clusters without overlapping clusters while still representing similarities between the clusters by placing them a relative distance away from each other. Visualization system 118 may generate visualization 119 to vary display of cluster 116 on display device 120 based on user input. In an embodiment, a user may identify desired scaling to be applied to cluster 116. In other embodiments, visualization system 118 may automatically scale visualization 119 based on cluster 116, model 112, dataset 108, predetermined user settings, or combinations thereof. Visualization system 118 may initially automatically scale visualization 119 but then allow a user to manually further scale visualization 119.

In an embodiment, a demographics dataset may contain age and salary. If clustering is performed on those fields, salary will dominate the clusters while age is mostly ignored. This is not normally the desired behavior when clustering, hence the auto-scale fields (balance_fields in the API) option. When auto-scale is enabled, all the numeric fields will be scaled so that their standard deviations are a predetermined value, e.g., 1. This makes each field have roughly equivalent influence. Visualization system 118 may allow for selecting a scale for each field.

System 100 may be implemented in any or a combination of computing devices 202 shown in FIG. 2 as described in more detail below.

FIG. 2 is a diagram an embodiment of a computing system 200 that executes the predictive modeling system 100 shown in FIG. 1. Referring to FIG. 2, system 200 includes at least one computing device 202. Computing device 202 may execute instructions of application programs or modules stored in system memory, e.g., memory 206. The application programs or modules may include components, objects, routines, programs, instructions, algorithmic structures, data structures, and the like that perform particular tasks or functions or that implement particular abstract data types as discussed above. Some or all of the application programs may be instantiated at run time by a processing device 204. A person of ordinary skill in the art will recognize that many of the concepts associated with the exemplary embodiment of system 200 may be implemented as computer instructions, firmware, or software in any of a variety of computing architectures, e.g., computing device 202, to achieve a same or equivalent result.

Moreover, a person of ordinary skill in the art will recognize that the exemplary embodiment of system 200 may be implemented on other types of computing architectures, e.g., general purpose or personal computers, hand-held devices, mobile communication devices, gaming devices, music devices, photographic devices, multi-processor systems, microprocessor-based or programmable consumer electronics, minicomputers, mainframe computers, application specific integrated circuits, and like. For illustrative purposes only, system 200 is shown in FIG. 2 to include computing devices 202, geographically remote computing devices 202R, tablet computing device 202T, mobile computing device 202M, and laptop computing device 202L. A person of ordinary skill in the art may recognize that computing device 202 may be embodied in any of tablet computing device 202T, mobile computing device 202M, or laptop computing device 202L. Similarly, a person of ordinary skill in the art may recognize that the predictive modeling system 100 may be implemented in computing device 202, geographically remote computing devices 202R, and the like. Mobile computing device 202M may include mobile cellular devices, mobile gaming devices, mobile reader devices, mobile photographic devices, and the like.

A person of ordinary skill in the art will recognize that an exemplary embodiment of system 100 may be implemented in a distributed computing system 200 in which various computing entities or devices, often geographically remote from one another, e.g., computing device 202 and remote computing device 202R, perform particular tasks or execute particular objects, components, routines, programs, instructions, data structures, and the like. For example, the exemplary embodiment of system 200 may be implemented in a server/client configuration (e.g., computing device 202 may operate as a server and remote computing device 202R may operate as a client). In distributed computing systems, application programs may be stored in local memory 206, external memory 236, or remote memory 234. Local memory 206, external memory 236, or remote memory 234 may be any kind of memory, volatile or non-volatile, removable or non-removable, known to a person of ordinary skill in the art including random access memory (RAM), flash memory, read only memory (ROM), ferroelectric RAM, magnetic storage devices, optical discs, and the like.

The computing device 202 comprises processing device 204, memory 206, device interface 208, and network interface 210, which may all be interconnected through bus 212. The processing device 204 represents a single, central processing unit, or a plurality of processing units in a single or two or more computing devices 202, e.g., computing device 202 and remote computing device 202R. The local memory 206, as well as external memory 236 or remote memory 234, may be any type memory device known to a person of ordinary skill in the art including any combination of RAM, flash memory, ROM, ferroelectric RAM, magnetic storage devices, optical discs, and the like. Local memory 206 may store a basic input/output system (BIOS) 206A with routines executable by processing device 204 to transfer data, including data 206E, between the various elements of system 200. The local memory 206 also may store an operating system (OS) 206B executable by processing device 204 that, after being initially loaded by a boot program, manages other programs in the computing device 202. Memory 206 may store routines or programs executable by processing device 204, e.g., application 206C, and/or the programs or applications 206D generated using application 206C. Application 206C may make use of the OS 206B by making requests for services through a defined application program interface (API). Application 206C may be used to enable the generation or creation of any application program designed to perform a specific function directly for a user or, in some cases, for another application program. Examples of application programs include word processors, database programs, browsers, development tools, drawing, paint, and image editing programs, communication programs, and tailored applications as the present disclosure describes in more detail, and the like. Users may interact directly with computing device 202 through a user interface such as a command language or a user interface displayed on a monitor (not shown).

Device interface 208 may be any one of several types of interfaces. The device interface 208 may operatively couple any of a variety of devices, e.g., hard disk drive, optical disk drive, magnetic disk drive, or the like, to the bus 212. The device interface 208 may represent either one interface or various distinct interfaces, each specially constructed to support the particular device that it interfaces to the bus 212. The device interface 208 may additionally interface input or output devices utilized by a user to provide direction to the computing device 202 and to receive information from the computing device 202. These input or output devices may include voice recognition devices, gesture recognition devices, touch recognition devices, keyboards, monitors, mice, pointing devices, speakers, stylus, microphone, joystick, game pad, satellite dish, printer, scanner, camera, video equipment, modem, monitor, and the like (not shown). The device interface 208 may be a serial interface, parallel port, game port, firewire port, universal serial bus, or the like.

A person of ordinary skill in the art will recognize that the system 200 may use any type of computer readable medium accessible by a computer, such as magnetic cassettes, flash memory cards, compact discs (CDs), digital video disks (DVDs), cartridges, RAM, ROM, flash memory, magnetic disc drives, optical disc drives, and the like. A computer readable medium as described herein includes any manner of computer program product, computer storage, machine readable storage, or the like.

Network interface 210 operatively couples the computing device 202 to one or more remote computing devices 202R, tablet computing devices 202T, mobile computing devices 202M, and laptop computing devices 202L, on a local or wide area network 230. Computing devices 202R may be geographically remote from computing device 202. Remote computing device 202R may have the structure of computing device 202, or may operate as server, client, router, switch, peer device, network node, or other networked device and typically includes some or all of the elements of computing device 202. Computing device 202 may connect to network 230 through a network interface or adapter included in the interface 210. Computing device 202 may connect to network 230 through a modem or other communications device included in the network interface 210. Computing device 202 alternatively may connect to network 230 using a wireless device 232. The modem or communications device may establish communications to remote computing devices 202R through global communications network 230. A person of ordinary skill in the art will recognize that application programs 206D or modules 206C might be stored remotely through such networked connections. Network 230 may be local, wide, global, or otherwise and may include wired or wireless connections employing electrical, optical, electromagnetic, acoustic, or other carriers.

The present disclosure may describe some portions of the exemplary system using algorithmic structures and symbolic representations of operations on data bits within a memory, e.g., memory 206. A person of ordinary skill in the art will understand these algorithmic structures and symbolic representations as most effectively conveying the substance of their work to others of ordinary skill in the art. An algorithmic structure is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For simplicity, the present disclosure refers to these signals as bits, values, elements, symbols, characters, terms, numbers, or like. The terms are merely convenient labels. A person of skill in the art will recognize that terms such as computing, calculating, generating, loading, determining, displaying, or like refer to the actions and processes of a computing device, e.g., computing device 202. The computing device 202 may manipulate and transform data represented as physical electronic quantities within a memory into other data similarly represented as physical electronic quantities within the memory.

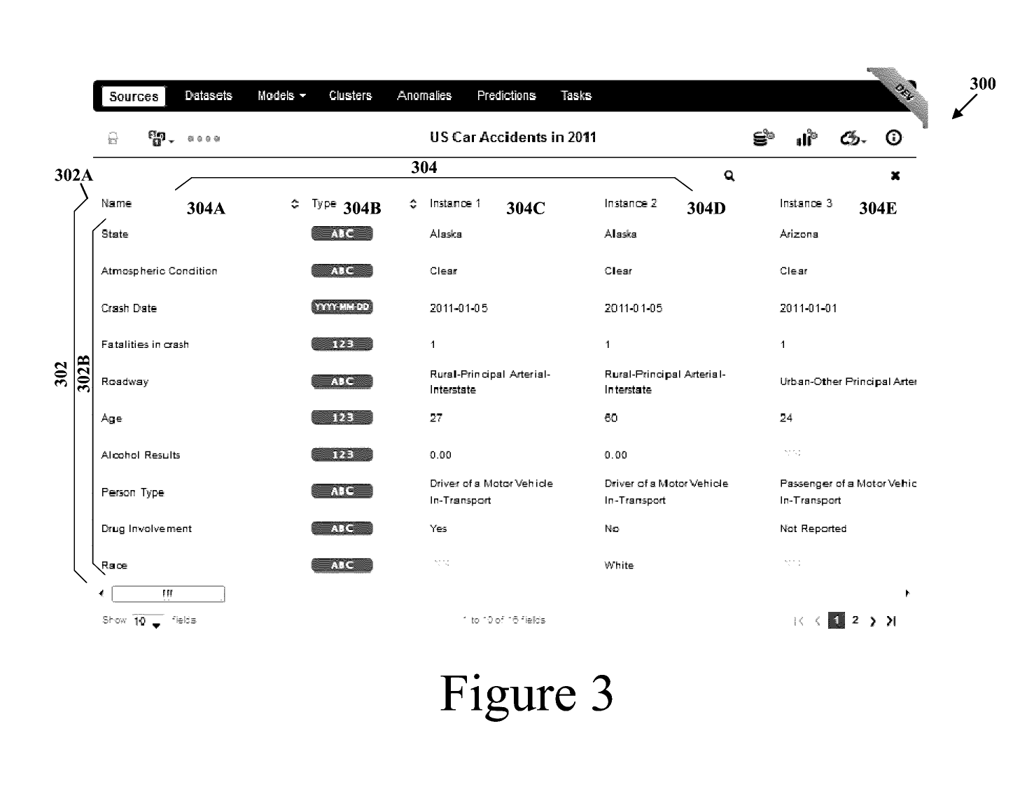

FIG. 3 is a display of exemplary data 300 according to the present disclosure. Referring to FIG. 3, data 300 may include a plurality of rows 302, each column representing a field, and a plurality of columns 304, each column representing an instance of the set of fields represented by the plurality of rows. For example, an instance represented by a particular column may comprise a credit record for an individual and the attributes represented by a plurality of rows may include age, salary, address, employment status, and the like. In another example, the instance (column) may comprise a medical record for a patient in a hospital and the attributes (rows) may comprise age, gender, blood pressure, glucose level, and the like. In yet another example, the instance (column) may comprise a stock record and the attributes (rows) may comprise an industry identifier, a capitalization value, and a price to earnings ratio for the stock.

A header row 302A may identify or label fields or instances. For example, name column 304A identifies the name of the field or instance. Field rows 302B may identify fields or features included in data 300, e.g., state, atmospheric condition, crash data, fatalities in crash, roadway, and the like. Each field row 302B may have a corresponding type, e.g., numerical, categorical, textual, date-time, or otherwise indicated in type column 304B. For example, row 302B_1 identifies a field “state” that is a categorical (non-numeric) type and row 302B_3 identifies a field “fatalities in crash” that is a numeric type, as indicated in column 304B. Columns 304C-E may identify specific instances of the particular fields or features identified in each row 302B. Data 103 or data 300 may be stored in any memory device such as those shown in FIG. 2, either locally or remote to system 100. Data sources are well known to those of ordinary skill in the art and may comprise any kind of data hierarchical, numerical, textual, or otherwise.

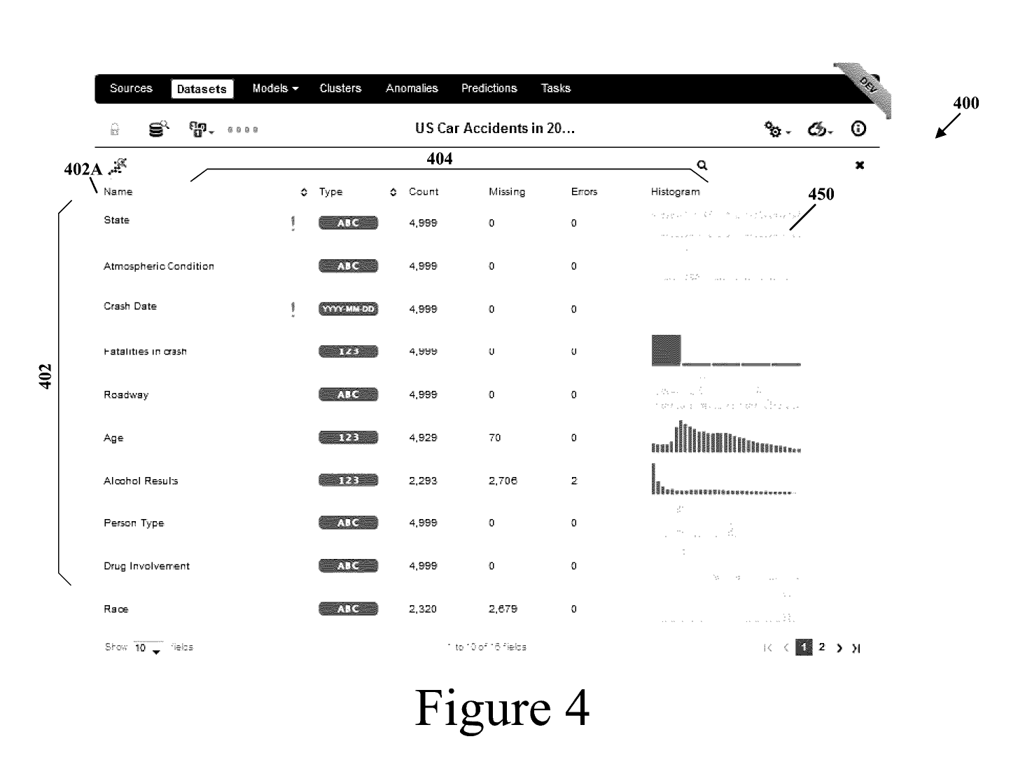

FIG. 4 is a display of an exemplary dataset 400 according to the present disclosure. Referring to FIG. 4, like data 300, dataset 400 may include a plurality of rows 402 and columns 404. A header row 402A may identify or label fields or other characteristics of data source 300. A column 404 may represent a particular variable of dataset 400, e.g., name, type, count, missing, errors, and histogram. Dataset 400 may comprise data for one or more fields corresponding to field rows 402, e.g., state, atmospheric condition, crash date, age, and the like. Datasets are well known to persons of ordinary skill in the art.

Dataset 400 may include a histogram 450 for each field row 402. Selecting a histogram 450 by any means, e.g., by clicking on histogram 450, hovering the mouse over histogram 450 for a predetermined amount of time, touching histogram 450 using any kind of touch screen user interface, gesturing on a gesture sensitive system, or the like may result in display of a pop up window (not shown) with additional specific information about the selected histogram. In an embodiment, the pop up window over a histogram may show, for each numeric field, the minimum, the mean, the median, maximum, and the standard deviation. Similarly, selecting any field in dataset 400 may yield further information regarding the selected field.

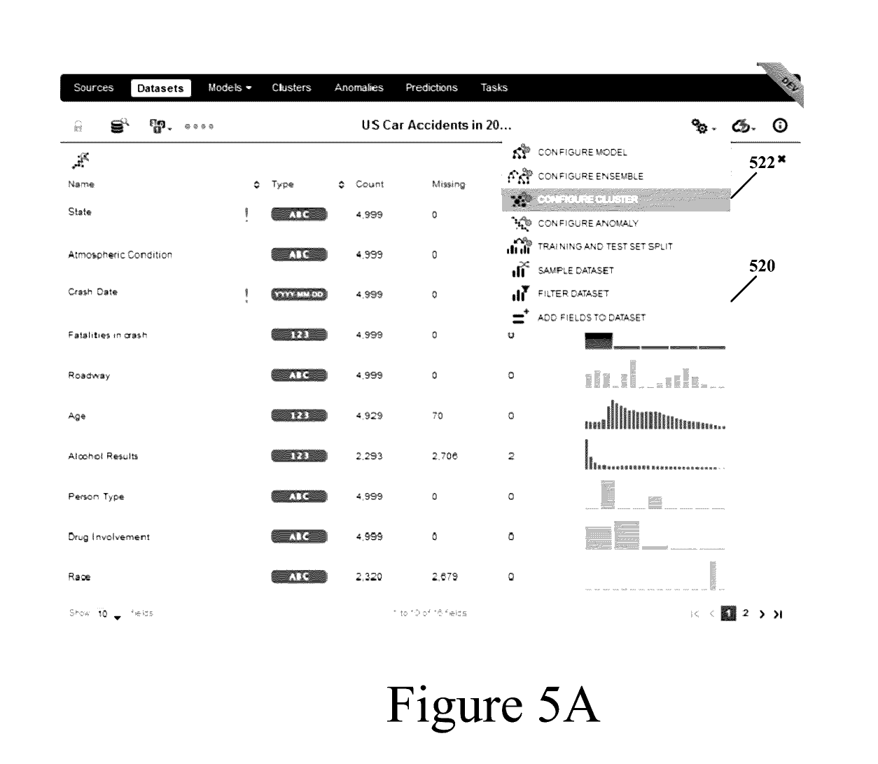

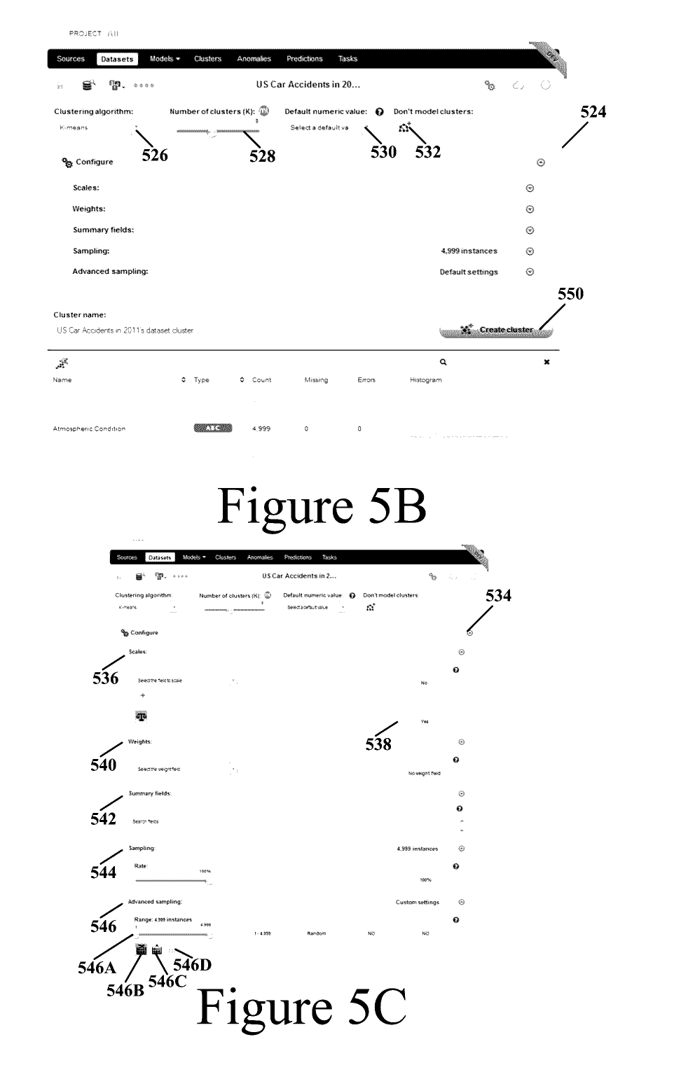

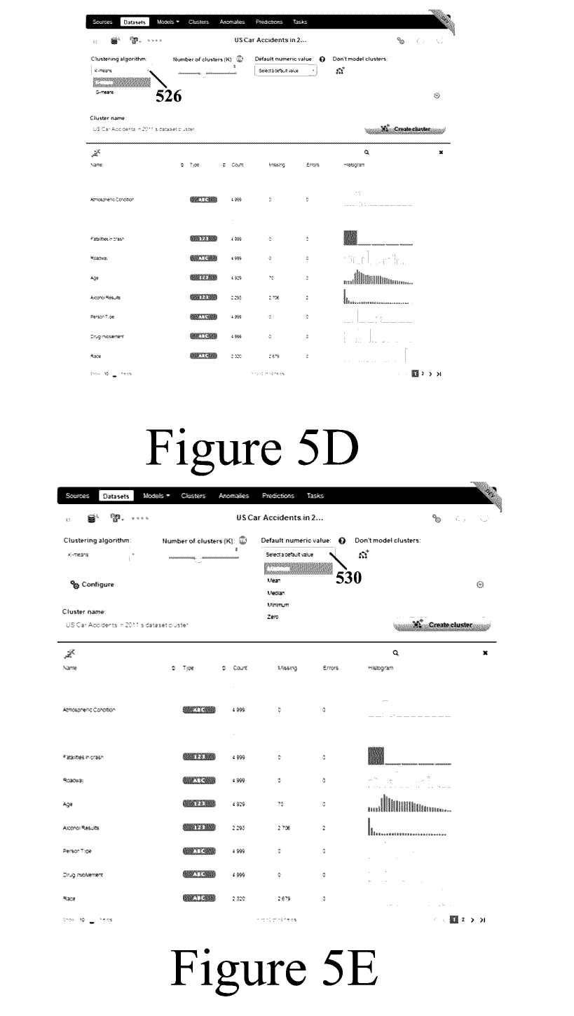

In an embodiment, visualization system 118 may generate an interactive graphical user interface 500 for configuration of system 100 including dataset generator 106, model generator 110, cluster generator 114, or the like. Referring to FIGS. 1, 4, and 5A-5E, visualization system 118 may display a pull down menu 520 that includes various actions available to be taken on dataset 400, e.g., configure model, configure ensemble, configure cluster, configure anomaly, training and test set split, sample dataset, filter dataset, and add fields to dataset. Visualization system 118 may replace display 500 with a display of an interface 524 upon receiving an indication of selection of the “configure cluster” pull down menu 522. Interface 524 may include user input fields, e.g., 526, 528, 530, and 532 to configure cluster generator 114.

Clustering algorithmic structure field 526 may be a pull down menu to allow the user to select between different algorithmic structures that cluster generator 114 may use to generate cluster 116. Clustering algorithmic structure field 526 may allow the user to select, e.g., between a k-means algorithmic structure, k-means++, k-means II, or a g-means algorithmic structure, although a user may be allowed to select between any clustering algorithmic structure that is known to a person of ordinary skill in the art. In an embodiment, if a user does not pick a number of clusters k, then visualization algorithmic structure may use g-means and automatically select a number of clusters for the dataset.

A number of clusters field 528 may allow a user to set a slider or other graphical device to a number of desired clusters k. Cluster generator 114 may generate cluster 116 including the desired k clusters in response to setting the number of clusters field 528.

A default numeric value field 530 may allow a user to select a default value, numeric or otherwise, that is assigned to missing values in dataset 400. The default value may be set to a maximum, mean, median, minimum, zero, or the like.

Model generator 110 may generate a model 112 for each cluster in 116 by selection of a create cluster model icon 532. Model generator 110 may do so in response to cluster generator 114 generating cluster 116 and by selection of cluster model icon 532. Put differently, model generator 110 may generate a model 112 of each cluster in 116 upon selection of cluster model icon 532 during configuration of cluster 116.

Visualization system 118 may allow a user to configure cluster generator 114 using cluster settings menu 534. For example, scales menu 536 may allow for scaling certain fields within dataset 400 using, e.g., integer multipliers so as to increase their influence in the distance computation. For fields that are not selected, cluster generator 114 may apply a scale of a predetermined value, e.g., 1. Auto scaled fields 538 may automatically scale all the numeric fields so that their standard deviation is 1 and their corresponding influence equivalent.

Weight field 540 may allow for each instance to be weighted individually according to the weight field's value. Any numeric field with no negative or missing values may be used as a weight field.

Summary field 542 may specify fields that will be included when generating each clusters' summaries, but will not be used for clustering.

Sampling field 544 may specify the percentage of dataset 400 that cluster generator 114 uses to generate cluster 116.

Advanced sampling field 546 may specify a range 546A that sets a linear subset of the instances of dataset 400 to include in the generation of cluster 116. If the full range is not selected, then a default sample rate is applied over the specified range. Sampling icon 546B may determine whether cluster generator 114 applies random sampling or deterministic sampling to dataset 400 over the specified range 546A. Deterministic sampling may allow a random number generator to use a same seed to produce repeatable results. Replacement icon 546C determines whether a sample is made with or without replacement. Sampling with replacement allows a single instance to be selected multiple times while sampling without replacement ensures that each instance is selected exactly once. Out of bag icon 546D may allow selection of an instance to exclude from deterministic sampling (considered out of the bag). Out of bag icon 546D will select only the out-of-bag instances for the currently defined sample. This can be useful for splitting a dataset into training and testing subsets. Out of bag icon 546D may only be selectable when a sample is deterministic and the sample rate is less than 100%.

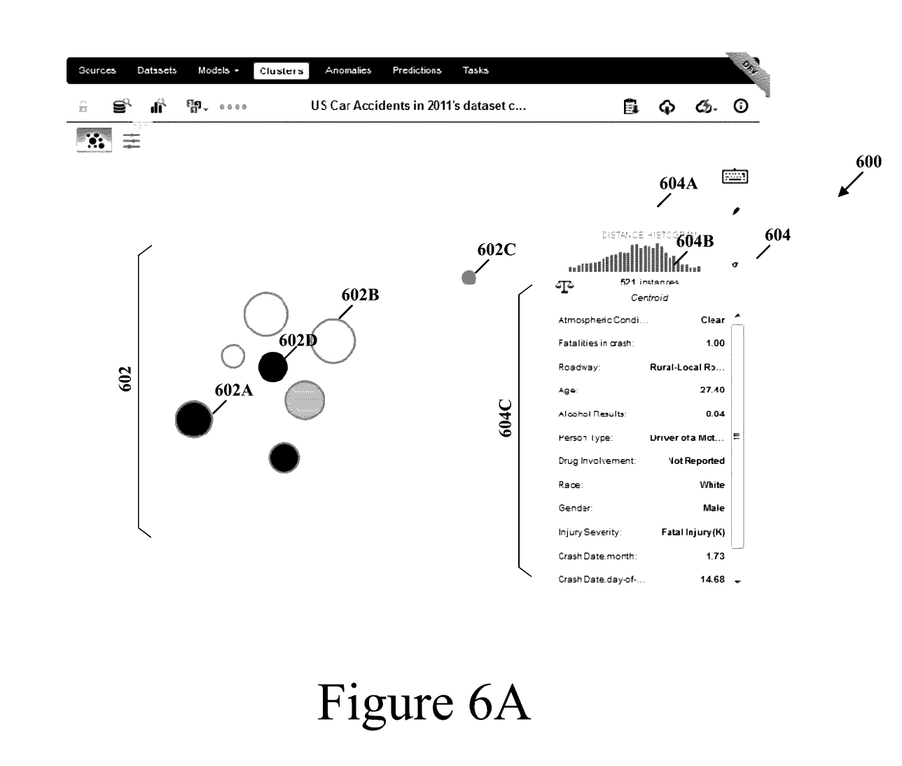

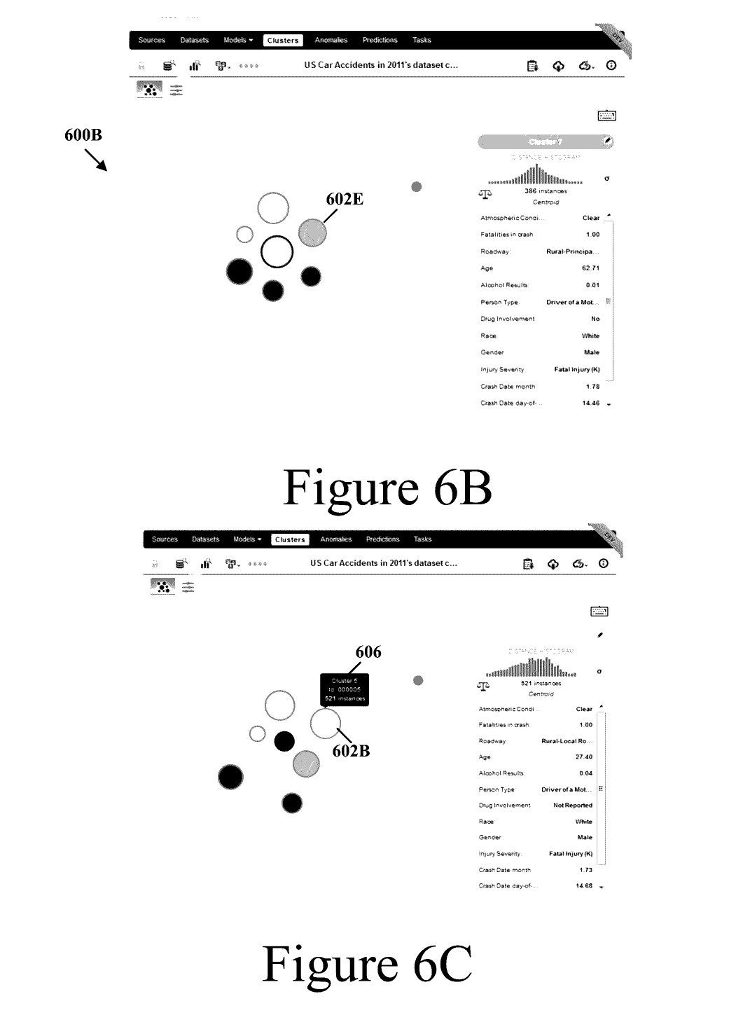

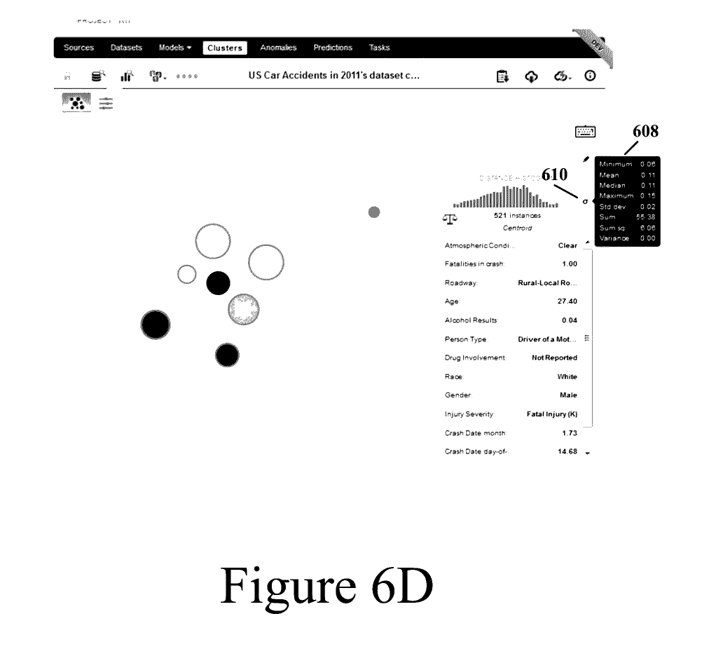

Cluster generator 114 may generate cluster 116 based on dataset 108 after selection of create cluster icon 550 on interface 524. Once generated, visualization system 118 may display cluster 116 on a display device 120 as shown in FIGS. 6A-6D. Cluster 116 may be visualized, rendered, graphed, or displayed as cluster graph 600 including a k number of clusters 602, with each cluster 602 being represented by a circle, in turn, representing a group of data points in the dataset 108 that have some degree of similarity in one or more attributes or fields. In an embodiment, a size of each cluster 602 represents a relative number of instances included in the cluster. For example, cluster 602A may be shown as larger than cluster 602C since cluster 602A includes 343 instances while cluster 602C includes 28 instances. Similarly, cluster 602A may be shown as smaller than cluster 602B since cluster 602A includes 343 instances while cluster 602B includes 521 instances. In an embodiment, each cluster 602 is shown with a different color to distinguish one cluster from another. Further, a distance between clusters indicates the relative similarity between clusters. Thus, cluster 602A is more similar to cluster 602B than it is to cluster 602C. Additionally, in an embodiment, visualization system 118 may apply a force or repulsion algorithmic structure to ensure that cluster graph 600 is drawn in a manner to minimize overlapping clusters 602 by assigning forces based on their relative positions. Thus, visualization system 118 may apply a force or repulsion algorithmic structure to cluster graph 600 after its initial display that causes the individual clusters to move about the screen for a predetermined time period until settling to a final location. Force or repulsion algorithmic structures are well known to persons of ordinary skill in the art.

Cluster graph 600 may include a cluster window 604 to detail the characteristics of the data instances contained within a selected cluster, e.g., cluster 602B. Cluster window 604 may be displayed upon selection of the particular cluster, e.g., cluster 602B at the center of cluster graph 600, or by hovering a mouse over the cluster, e.g., cluster 602E as shown in FIG. 6B. Cluster window 604 may include a title bar 604A indicating the particular cluster for which information is being provided, e.g., cluster 602B (FIG. 6A) or cluster 602E (FIG. 6B). A distance histogram 604B may display a histogram of distances between each data instance and a centroid of the corresponding cluster 602B (FIG. 6A) or cluster 602E (FIG. 6B). Data fields 604C may display characteristic fields of the data instances in the corresponding cluster 602B (FIG. 6A) or cluster 602E (FIG. 6B).

Visualization system 118 may redraw cluster graph 600 in response to selection of a cluster by placing the selected cluster at the center of graph 600. For example, visualization system 118 may replace cluster graph 600 having cluster 602D at the center with cluster graph 600B having cluster 602B at the center as shown in FIG. 6B in response to having received an indication of selection of cluster 602B. And visualization system 118 may optionally apply a force or repulsion algorithmic structure to cluster graph 600B after its initial display to ensure that no clusters overlap.

Visualization system 118 may further display a pop up window 606 (FIG. 6C) over cluster 602B upon selection of cluster 602B by any means known to a person of ordinary skill in the art including by clicking or hovering the mouse over cluster 602B. Pop up window 606 may identify the cluster and the number of instances included in the cluster.

Visualization system 118 may further display a pop up window 608 over cluster window 604 upon selection of sigma icon 610. Sigma icon 610 may be selected by any means known to a person of ordinary skill in the art including by clicking or hovering the mouse over sigma icon 610 for a predetermined amount of time. Pop up window 608 may display statistics associated with the instances included in a corresponding cluster, in this case cluster 602B. The statistics may include minimum, mean, median, maximum, standard deviation, sum, sum squared, variance, and the like.

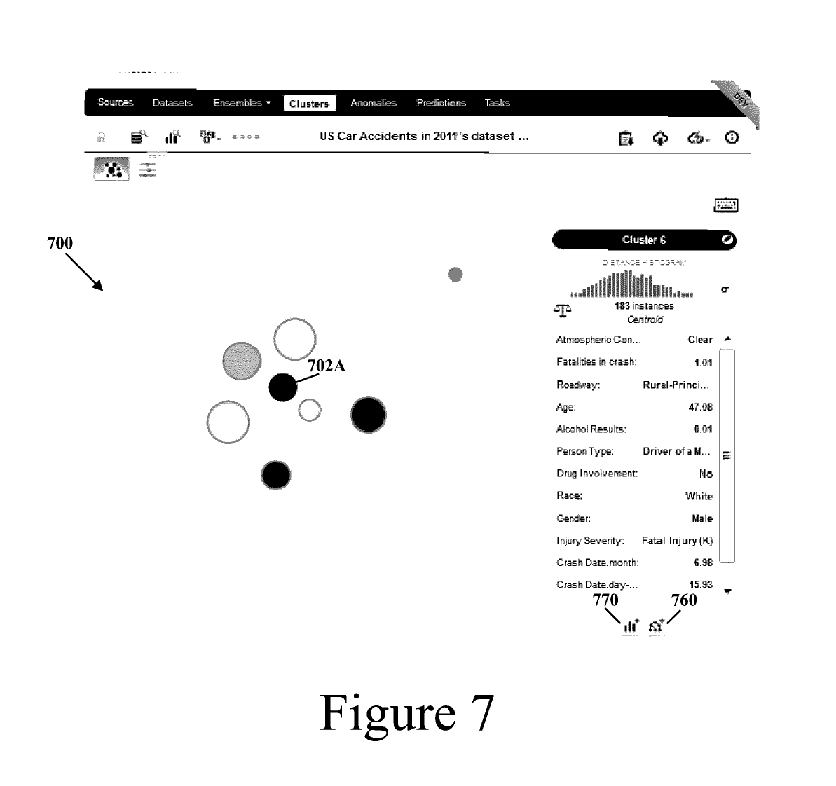

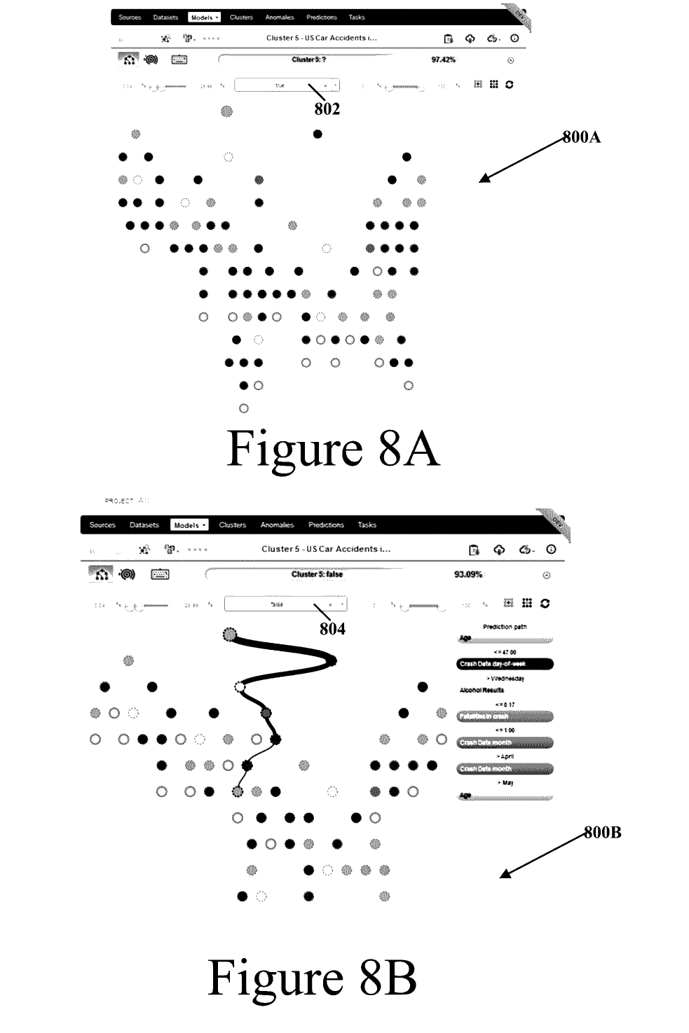

FIG. 7 is an exemplary graphical user interface to display a cluster and corresponding models of each cluster shown in FIGS. 6A-D according to the present disclosure. Referring to FIGS. 1, 4, 5A-5E, and 7, cluster graph 700 may include a cluster model icon 760 that appears in response to having configured model generator 110 to generate a cluster model 112 for each cluster by, e.g., selecting create cluster model icon prior to generating cluster 116. In an embodiment, visualization system 118 replaces display of cluster graph 700 with a display of a model 800A or 800B (FIG. 8A or 8B) of the cluster 702A in response to selection of cluster model icon 760. Note that model generator 110 created models 800A and 800B for each cluster generated for cluster 116 in response to selection of cluster model icon 432 during configuration of cluster 116. Models 800A or 800B may be stored after generation and before display on display device 120 on any memory shown in FIG. 2. Models 800A or 800B may allow for the classification of new data 104 (FIG. 1). In an embodiment, visualization system 118 may display model 800A as a decision tree for determining whether a new data instance 104 belongs in cluster 702A as indicated by menu 802 in FIG. 8A. Alternatively, visualization system 118 may display model 800B as a decision tree for determining whether new data instance 104 does not belong in cluster 702A as indicated by menu 804 in FIG. 8B. Visualization system 118 allows for toggling between display of the models 800A and 800B by selecting either true or false on menu 802. The creation and visualization of models 800A and 800B as decision trees is described in commonly-assigned U.S. patent application Ser. No. 14/495,802, filed Sep. 24, 2014 and titled Interactive Visualization System and Method, which the present disclosure incorporates by reference in its entirety.

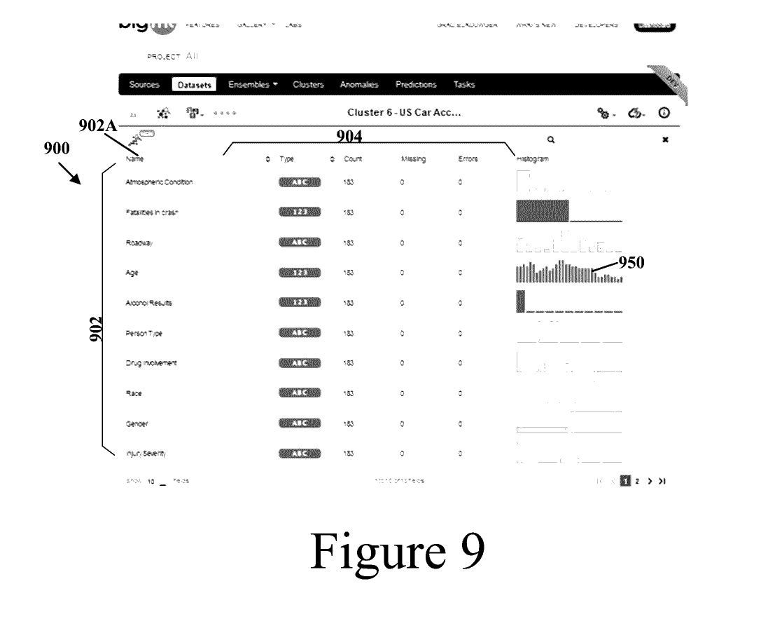

Cluster dataset icon 770 may trigger creation of a dataset for the corresponding cluster, e.g., cluster 702A. In an embodiment, visualization system 118 may replace display of cluster graph 700 with a display of dataset 900 corresponding to cluster 702A as shown in FIG. 9. Dataset 900 may include a plurality of rows 902 and columns 904. A header row 902A may identify or label fields or other characteristics of the data instances included in the cluster 702A (FIG. 7). A column 904 may represent a particular variable, e.g., name, count, missing, errors, and histograms. Dataset 900 may comprise data for one or more fields corresponding to field rows 902, e.g., state, atmospheric condition, fatalities in crash, roadway, age, and the like. Datasets, e.g., dataset 900, are well known to those of ordinary skill in the art.

In an embodiment, selecting a histogram, e.g., histogram 950, by any means, e.g., by clicking on a node using any kind of mouse, hovering over a node for a predetermined amount of time using any kind of cursor, touching a node using any kind of touch screen, gesturing on a gesture sensitive system and the like, may result in display of a pop up window with additional specific information about the selected histogram. In an embodiment, a pop up window (not shown) over a histogram may show, for each numeric field, the minimum, the mean, the median, maximum, and the standard deviation. Similarly, selecting any field in dataset 900 may yield further information regarding that field.

Persons of ordinary skill in the art will recognize that the present disclosure is not limited to what has been particularly shown and described hereinabove. Rather, the scope of the present disclosure includes both combinations and sub-combinations of the various features described hereinabove as well as modifications and variations that would occur to such skilled persons upon reading the foregoing description without departing from the underlying principles. Only the following claims, however, define the scope of the present disclosure.

1. A method, comprising:
creating, using a computing device, a dataset from a data source comprising data points;
identifying, using the computing device, a number of clusters based at least in part on a similarity metric between the data points;
generating, using the computing device, a model for each of the number of clusters based at least in part on identifying the number of clusters;
visually displaying, using the computing device, the number of clusters on a display device; and
replacing, using the computing device, the visual display of the number of clusters on the display device with a visual display of the model corresponding to a particular cluster in response to receiving an indication of selection of a model icon.

2. The method of claim 1, wherein the visually displaying the number of clusters occurs in response to selection of a create cluster icon.

3. The method of claim 1, wherein visually displaying the number of clusters further comprises modifying the visual display of the number of clusters to ensure that that none of clusters overlaps another cluster.

4. The method of claim 1, wherein visually displaying the number of clusters further comprises representing each cluster with a size proportional to a number of data points comprised therein.

5. The method of claim 1,
wherein identifying the number of clusters occurs in response to receiving an indication of selection of a generate cluster icon; and
wherein generating the model for each of the number of clusters occurs in response to receiving an indication of a selection of a generate model icon.

6. The method of claim 1, wherein the model for each of the number of clusters is configured to predict whether a new data point belongs to the corresponding cluster.

7. The method of claim 1, further comprising:
storing the model for each of the number of clusters in a memory device; and
retrieving the model for the particular cluster from the memory device prior to visually displaying the model for the particular cluster on the display device.

8. A system, comprising:
a memory device configured to store instructions; and
one or more processors configured to execute the instructions stored in the memory device to:
create a dataset from a data source comprising data points;
identify a number of clusters based at least in part on a similarity metric between the data points;
generate a model for each of the number of clusters based at least in part on identifying the number of clusters;
visually display the number of clusters on a display device; and
replace the visual display of the number of clusters on the display device with a visual display of the model corresponding to a particular cluster in response to receiving an indication of selection of a model icon.

9. The system of claim 8, wherein the one or more processors is configured to execute the instructions stored in the memory device further to visually display the number of clusters in response to selection of a create cluster icon.

10. The system of claim 8, wherein the one or more processors is configured to execute the instructions stored in the memory device further to modify the visual display of the number of clusters to ensure that that none of clusters overlaps another cluster.

11. The system of claim 8, wherein the one or more processors is configured to execute the instructions stored in the memory device further to visually represent each cluster with a size proportional to a number of data points comprised therein.

12. The system of claim 8, wherein the one or more processors is configured to execute the instructions stored in the memory device further to:
identify the number of clusters occurs in response to selection of a generate cluster icon; and
generate the model for each of the number of clusters occurs in response to selection of a generate model icon.

13. The system, of claim 8, wherein the one or more processors is configured to execute the instructions stored in the memory device further to, for each of the number of clusters, predict whether a new data point belongs to the corresponding cluster.

14. The system of claim 8, wherein the one or more processors is configured to execute the instructions stored in the memory device further to:
store the model for each of the number of clusters in a memory device; and
retrieve the model for the particular cluster from the memory device before visually displaying the model for the particular cluster on the display device.

15. A physical computer-readable medium comprising instructions stored thereon that, when executed by one or more processing devices, cause the one or more processing devices to:
create a dataset from a data source comprising data points;
identify a number of clusters based at least in part on a similarity metric between the data points;
generate a model for each of the number of clusters based at least in part on identifying the number of clusters;
visually display the number of clusters on a display device; and
replace the visual display of the number of clusters on the display device with a visual display of the model corresponding to a particular cluster in response to receiving an indication of selection of a model icon.

16. The physical computer-readable medium of claim 15, wherein executing the instructions further cause the one or more processing devices to visually display the number of clusters in response to selection of a create cluster icon.

17. The physical computer-readable medium of claim 15, wherein executing the instructions further cause the one or more processing devices to modify the visual display of the number of clusters to ensure that that none of clusters overlaps another cluster.

18. The physical computer-readable medium of claim 15, wherein executing the instructions further cause the one or more processing devices to visually represent each cluster with a size proportional to a number of data points comprised therein.

19. The physical computer-readable medium of claim 15, wherein executing the instructions further cause the one or more processing devices to:
identify the number of clusters occurs in response to selection of a generate cluster icon; and
generate the model for each of the number of clusters occurs in response to selection of a generate model icon.

20. The physical computer-readable medium of claim 15, wherein executing the instructions further cause the one or more processing devices to, for each of the number of clusters, predict whether a new data point belongs to the corresponding cluster.
